(19) United States
(12) Patent Application Publication
(10) Pub. No.: US 2011/0161140 A1
(43) Pub. Date: Jun. 30, 2011

(54) ONBOARD UNIT FOR A ROAD TOLL SYSTEM

(75) Inventors: Michael Polt, Wien (AT); Sören Schrödl, Modling (AT); Refi-Tugrul Güner, Baden (AT); Oliver Nagy, Wien (AT)

(73) Assignee: KAPSCH TRAFFICCOM AG, Wien (AT)

(21) Appl. No.: 12/903,923

(22) Filed: Oct. 13, 2010

(30) Foreign Application Priority Data
Oct. 15, 2009 (EP) 09450197.0

(51) Int. Cl. G07B 15/06; G06K 9/00; H04N 7/18

(52) U.S. Cl. 705/13; 382/103; 348/148; 348/E07.085

(57) ABSTRACT

An onboard unit for a road toll system including: at least one transceiver for transmitting toll-relevant data to transceiver stations for forwarding to a central processing unit of the road toll system; at least one camera, which is directed towards a passenger compartment of a vehicle carrying the onboard unit and can create at least one image recording of at least one section of the passenger compartment; and an evaluation unit connected down-line of the camera that detects and counts the passengers of the vehicle in the image recording.

### CROSS-REFERENCE TO RELATED APPLICATION(S)

This application claims the priority of the European Patent Application No. 09 450 197.0 of 15 Oct. 2009, the disclosure content of which is incorporated herein by reference.

### FIELD OF THE INVENTION

The present invention relates to an onboard unit for a road toll system with at least one transceiver for transmitting toll-relevant data to transceiver stations for forwarding to a central processing unit of the road toll system. The invention additionally relates to a method for the passenger number-dependent application of a toll to vehicles.

### BACKGROUND

Onboard units for road toll systems (OBUs) are used for locating vehicles and generating location-specific charge transactions such as road tolls, entry charges or parking fees. The aim of the invention is to provide a novel form of onboard unit that has an extended range of use, in particular for the passenger number-dependent application of a toll to vehicles.

### SUMMARY

A first aspect of the invention includes an onboard unit for a road toll system, comprising:

at least one transceiver for transmitting toll-relevant data to transceiver stations for forwarding to a central processing unit of the road toll system;

at least one camera, which is directed towards a passenger compartment of a vehicle carrying the onboard unit and can create at least one image recording of at least one section of the passenger compartment; and

an evaluation unit connected down-line of the camera that detects and counts the passengers of the vehicle in the image recording.

The invention is particularly suitable for the enforcement of hot lanes. Hot lanes are road lanes actually reserved for vehicles with several passengers, but may also be used by vehicles with less passengers so long as a—correspondingly passenger-dependent—toll is paid for usage. Therefore, the setting of the passenger number in the OBU is generally necessary for proper toll calculation for the use of a hot lane. For monitoring the correct setting of the OBU and punishing instances of toll avoidance on hot lanes, there is presently only the possibility of visually monitoring the vehicles from the road side, which is extremely time-consuming and practically impossible to achieve in extensive road toll systems. It has therefore already been proposed to use electronic image processing systems, which automatically detect and count the passengers in an image recording of the vehicle from outside the vehicle. However, reflections on the windscreen and shadowing of the rear passengers frequently lead to detection errors, and this renders these systems unusable for a large-scale commercial application.

The invention follows a different route and for the first time allows a direct detection of the passengers of the vehicle from the interior of the vehicle by means of a camera arranged in the OBU. Viewing problems as a result of windscreen reflections are completely excluded. Since it is additionally in the driver's interests to move all the passengers present into the viewing field of the OBU camera to take advantage of a lower hot lane toll, the shadowing problems associated with external controls hitherto are generally also excluded.

In an embodiment of the invention the transceiver transmits the number of passengers, and preferably also the image recording, to the central processing unit. As a result, the recorded images can be immediately evaluated centrally (online) or at a later time in the batch. In this case, the evaluation unit can obscure the detected vehicle passengers in the image recording before they are transmitted or render them anonymous for data protection or privacy purposes.

The onboard unit preferably contains a memory for archiving the image recording and/or the number of passengers. These can be collected for subsequent evaluation or batch transmission to the central processing unit.

A variant of the invention is distinguished in that at least one further camera is directed towards the vehicle environment, particularly preferred in front of the vehicle.

This variant opens up a plurality of new possibilities for monitoring and punishing toll avoidance. OBUs equipped with a forwardly directed camera can record the road use of other vehicles and/or report it to a central processing unit, as a result of which a plurality of potential monitoring elements are created. It is not necessary for all OBUs of the road toll system to be equipped and used in this way, it is sufficient, for example, for OBUs of special user groups to be equipped with such cameras, e.g. OBUs of police patrol vehicles or public service vehicles.

Other application purposes, e.g. the monitoring of the general traffic situation can be fulfilled, while assuring data protection, if according to a further preferred embodiment of the invention an evaluation unit, which detects license plate numbers of other vehicles in the image recording, is connected down-line of the camera directed towards the environment of the vehicle and optionally obscures these or renders them anonymous.

In both variants of the invention it is particularly advantageous if the onboard unit can be fastened in the region of the windscreen of the vehicle and the camera(s) is/are arranged on its front or rear side. As a result, the correct viewing directions to the front and into the passenger compartment can be achieved in a simple manner.

It is particularly favourable if the camera creates one or more image recordings in each case at periodic, predefined or random instants in time that are archived or transmitted to the central processing unit, for example. Alternatively, the camera can create at least one image recording in response to a request received via the transceiver, so that a centralised management of the system is possible.

A further embodiment of the actuation of the camera is that the onboard unit has an object detector, which upon detection of a given object in the vicinity of the vehicle causes the camera to record an image or images. Such an object can be, for example, an RFID (radio frequency identification) or DSRC (dedicated short-range communication) tag, e.g. an RFID or DSRC transponder chip integrated into a road sign, and accordingly the object detector is preferably an RFID or DSRC detector for wireless recognition of an RFID or DSRC object. Alternatively, the given object can be a visible object, e.g. a specific road sign, and the object detector is preferably an optical detector for detecting the presence of a visible object in the environment of the vehicle.

Such a visible object can in particular also be the presence of a vehicle in the vicinity of the OBU that is “worth recording”, e.g. a person in front in a line of vehicles. The optical detector preferably detects the presence of an object that may be remaining stationary in a moving environment of the vehicle: as a result of this, for example, the recording of the image is triggered precisely when a person in front is driving in front of the vehicle in a moving line of vehicles, which can be applied as criterion for actuating an image recording of the person in front.

A further variant of the invention is distinguished in that the onboard unit contains an acceleration sensor, which in the event of an acceleration exceeding a threshold causes the camera to record an image or images. As a result, an OBU equipped with one or more cameras can operate as a crash recorder, which in the event of an accident records images of the environment of the vehicle and/or the passenger compartment for purposes of evidence and can also transmit these to the central processing unit to raise the alarm.

According to a further feature of the invention, the onboard unit contains a satellite navigation receiver to provide the image recording(s) with the location and time data of its/their creation, which enhances its/their evidential weight and thus facilitates enforcement of the toll system.

All types of transceivers known in the art are suitable as transceivers that enable the onboard unit to communicate with the transceiver stations of the central processing unit. The transceiver is preferably a DSRC (dedicated short-range communication), WAVE (wireless access for vehicle environments) or mobile communications transceiver operating according to any desired mobile wireless standard such as GSM, GPRS, UMTS, WiMax etc. Accordingly, the transceiver stations of the central processing unit considered here can also be both locally distributed DSRC or WAVE beacons and base stations of a mobile wireless network.

The camera(s) and said optical detector can be of any type known in the art, e.g. CCD cameras. Interfering irradiation can be reduced in certain applications if the camera(s) and/or the optical detector are configured for narrow-band light, in particular infrared light. It is also possible to use so-called time of flight cameras for the camera(s) and/or the optical detector, which generate 3D image recordings.

In a second aspect the invention also provides a method for the passenger number-dependent application of a toll to a vehicle by means of an onboard unit of the type presented here, comprising:

creating an image recording of a passenger compartment of the vehicle by means of the camera of the onboard unit;

detecting and counting the passengers of the vehicle by means of the evaluation unit of the onboard unit; and

in the onboard unit, calculating a toll as a function of the number of passengers.

In a third aspect the invention provides a method for the passenger number-dependent application of a toll to a vehicle by means of an onboard unit of the type presented here, comprising:

creating an image recording of a passenger compartment of the vehicle by means of the camera of the onboard unit;

detecting and counting the passengers of the vehicle by means of the evaluation unit of the onboard unit;

transmitting the number of passengers to a central processing unit by means of the transceiver of the onboard unit; and

in the central processing unit, calculating a toll as a function of the received number of passengers.

### BRIEF DESCRIPTION OF THE DRAWINGS

The invention is explained in more detail below on the basis of an exemplary embodiment represented in the attached drawings:

FIG. 1 shows a vehicle equipped with an onboard unit according to the invention as part of a schematically represented road toll system;

FIG. 2 is a block diagram of the onboard unit of FIG. 1;

FIGS. 3 and 4 show the onboard unit of FIGS. 1 and 2 in rear and front view in its installation position on a windscreen; and

FIGS. 5 and 6 show two exemplary image recordings of the onboard unit of FIGS. 1-4.

### DETAILED DESCRIPTION

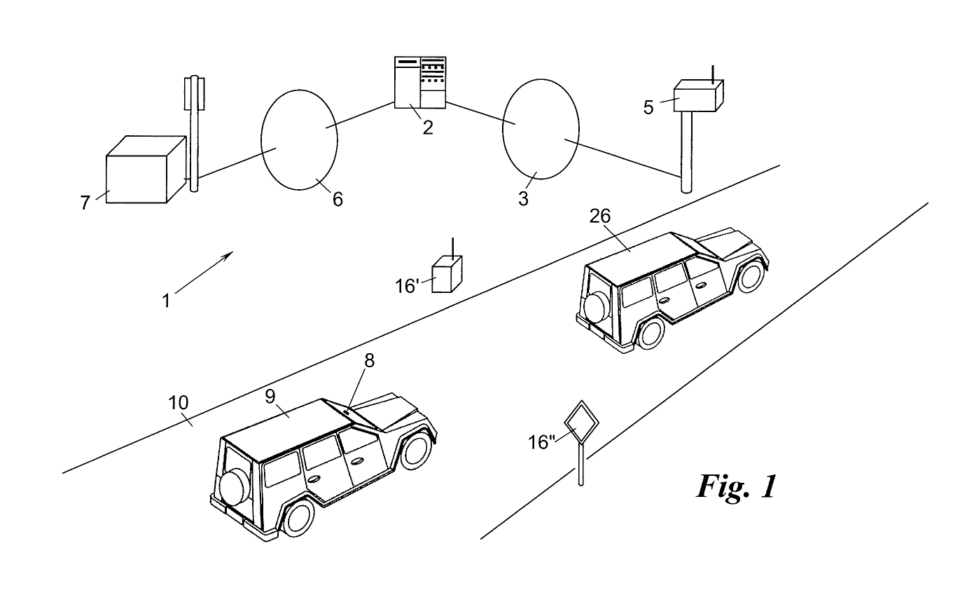

FIG. 1 shows an exemplary road toll system 1 only represented in sections with at least one central processing unit 2, which connects to a plurality of roadside transceiver stations 5, e.g. DSRC or WAVE wireless beacons. Alternatively or additionally thereto, the central processing unit 2 connects to a plurality of transceiver stations 7, e.g. base stations of a GSM mobile wireless network, via a second data network 6. The central processing unit 2 can communicate via the transceiver stations 5, 7 with onboard units or OBUs 8 that are carried by vehicles 9 in order to charge for their use of traffic areas 10 such as roads, motorways, car parks etc.

For the purposes of the present invention, the OBUs 8 can be of any desired type, e.g. OBUs with short-range communication, which can be localised by transceiver stations 5 in the form of DSRC wireless beacons, for example, that indicate the location of the OBU 8 to the central processing unit 2 for charging. Alternatively, the OBUs 8 can also be so-called thin clients or thick clients, which can determine their location themselves, e.g. by identifying the location of the radio beacons 5, by self-localisation in a mobile wireless network by means of the transceiver stations 7, or also by means of their own satellite navigation receiver for a global navigation satellite system (GNSS). Thick client OBUs 8 can determine road segments subject to a toll by means of their own maps, determine the toll charge and transmit it to the central processing unit 2. Thin client OBUs 8 can transmit their positions or the travelled route (tracks) directly to the central processing unit 2 for evaluation and the toll charge is determined therefrom in the central processing unit 2. All these different types of data transmissions to the central processing unit 2 are combined under the general term of “transmitting toll-relevant data” by an OBU 8 to the central processing unit 2.

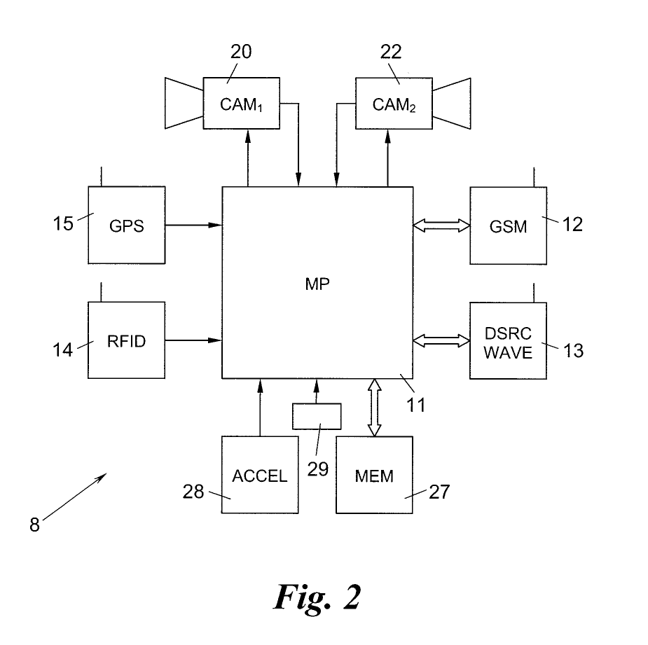

The structure of an OBU 8 is shown in detail in FIGS. 2 to 4. FIG. 2 is a block diagram of an OBU 8 with partly optional components. Simplified embodiments of the OBU 8 do not necessarily have all the components shown in FIG. 2.

According to FIG. 2, the onboard unit 8 comprises a central microprocessor 11, which cooperates with one or more transceivers 12, 13 to transmit toll-relevant data to the central processing unit 2. For example, the transceivers 12, 13 are a mobile wireless transceiver 12 operating according to the GSM standard, for example, and/or a short-range communication transceiver 13 operating according to the DSRC, WAVE or infrared standard and/or an RFID transceiver 14.

For self-localisation or tracking of the OBU, this can additionally be equipped with a satellite navigation receiver 15 and/or can use the RFID transceiver 14 for this, the latter being for the detection of roadside RFID objects 16′ (FIG. 1) with known location, e.g. RFID transponder chips with stored position data.

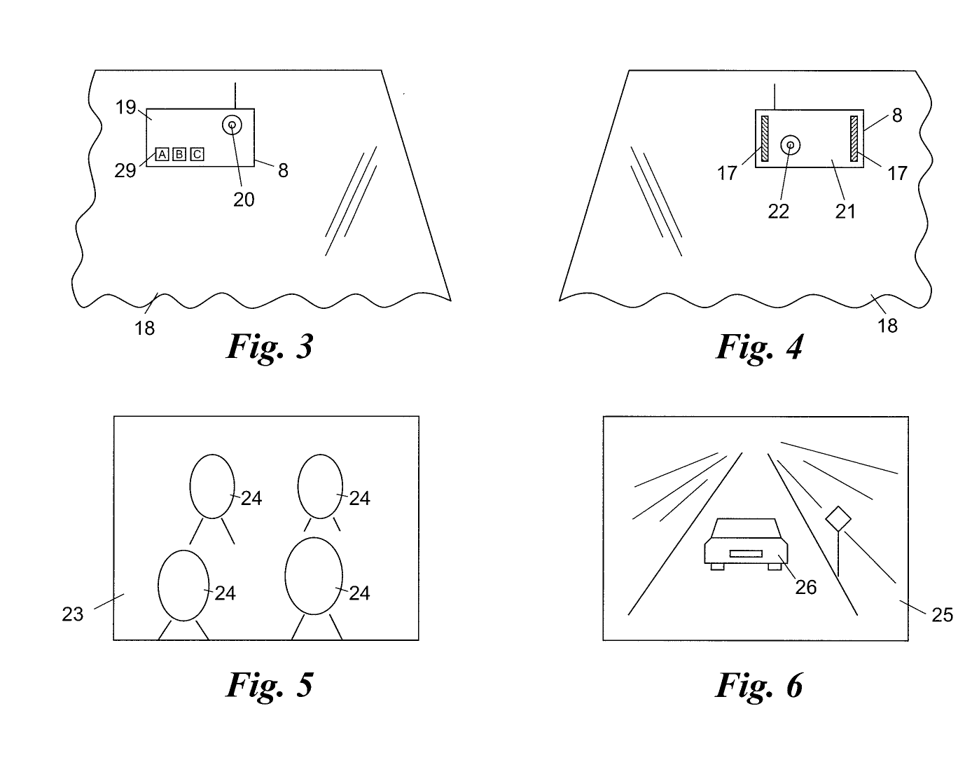

As shown in FIGS. 3 and 4, the OBU 8 is glued to the windscreen 18 of the vehicle 9 from the inside, for example, by means of adhesive strips 17. The OBU 8 is equipped with a first camera 20 on its rear side 19 facing the passenger compartment of the vehicle 9 and/or with a second camera 22 on its front side 21 pointing forwards in the direction of travel. Further cameras can be arranged to face sideways, for example, on the sides of the onboard unit 8.

In this position the first camera 20 records an image 23 (FIG. 5) of the passenger compartment of the vehicle 9, in which the number of passengers 24 of the vehicle can be determined, for example, by means of conventional image processing elements. In this position the second camera 22 records an image 25 of the vehicle environment in front of the vehicle 9, e.g. another vehicle 26 (person in front) travelling on the road 10 in front of the vehicle 9.

The detection of the passengers 24 of the vehicle in the image 23 of the camera 20 is preferably performed by the microprocessor 11 as evaluation unit. The number of passengers of the vehicle 9 detected by the microprocessor 11 can be used to calculate a passenger number-dependent toll, e.g. for the use of a hot lane by the vehicle 9. The toll calculation can be conducted both by the microprocessor 11 in the OBU 8 itself and in the central processing unit 2 of the road toll system 1. In the latter case, the microprocessor 11 transmits the detected number of passengers to the central processing unit 2 for evaluation.

The image recordings 23, 25 of the cameras 20, 22 and/or the number of passengers or the passenger number-dependent toll determined by the microprocessor 11 are optionally archived in a memory 27 of the OBU 8 for subsequent evaluation purposes. Alternatively or additionally thereto,—immediately after recording or at a later point in time, e.g. collected in the memory 27 as a batch—they are transmitted to the central processing unit 2 via one or more transceivers 12, 13, 14 and one or more transceiver stations 5, 7 for evaluation.

The cameras 20, 22 are caused to record one or more of the images 23, 25 by the microprocessor 11 and/or one or more of the components connected thereto, in particular according to the following criteria:
a) image recordings can be created periodically or at random points in time in a controlled manner;
b) the central processing unit 2 and/or its transceiver stations 5, 7 can transmit requests to the OBU 8, which this receives via its transceivers 12, 13, 14 and in response records images;
c) in association with the microprocessor 11 the satellite navigation receiver 15 can bring about image recordings [in?] the specific predefined positions;
d) upon detection of a given object in the vicinity of the vehicle 9, e.g. on detection of the RFID object 16′ or a visible object 16″, e.g. a road sign, an object detector contained in the OBU 8 can trigger image recording; such an object detector can be formed by the RFID transceiver 14, for example, which detects the presence of an RFID object 16′, or by the camera 22 itself directed towards the vehicle environment, which in cooperation with the microprocessor 11 detects a visible object 16″ by means of image processing elements and in response causes the camera 20 and/or the camera 22 to record an image 23;
e) such an object detector formed by the camera 22 can preferably also cause an image recording to occur precisely when it detects the presence of an object that possibly is remaining stationary in a moving environment of the vehicle 9, such as another vehicle 26 travelling in front;
f) an optional acceleration sensor 28 can be used to cause the camera 20 and/or the camera 22 to record an image in the event of an acceleration exceeding a given threshold or a crash of the vehicle 9, e.g. for evidence purposes and/or to thus send an accident notification to the central processing unit 2.

The satellite navigation receiver 15 can be used to additionally provide each of the image recordings 23, 25 of the cameras 20, 22 with the location and time data of their creation.

One or more of the transceivers 12, 13, 14, preferably the very same transceiver, used for transmitting the toll-relevant data to the central processing unit 2 can be used to send the image recordings 23, 25 of the cameras 20, 22 and/or the number of passengers or the passenger number-dependent toll determined by the microprocessor 11 to the central processing unit 2.

The OBU 8 can be optionally equipped with a keyboard 29, by means of which toll-relevant parameters can be input into the onboard unit 8 and/or the image recordings of the cameras 20, 22 can also be initiated manually.

The cameras 20, 22 (or the optical object detector) are preferably electronic, e.g. conventional CCD camera chips, which—in the manner of a film recording—continuously record consecutive single images; one or more of these single images can be respectively used as image recording(s) 23, 25 in the above sense.

So-called time of flight camera chips, which are capable of generating 3D image recordings in conjunction with an associated controlled light source, could also be used in place of CCD camera chips. It is also possible to configure the cameras 20, 22 and the optical object detector to be sensitive especially to narrow-band light, in particular infrared light.

The invention is not restricted to the represented embodiments, but covers all variants and modifications that fall within the scope of the attached claims.

1. An onboard unit for a road toll system, comprising:
at least one transceiver for transmitting toll-relevant data to transceiver stations for forwarding to a central processing unit of the road toll system
at least one camera, which is directed towards a passenger compartment of a vehicle carrying the onboard unit and can create at least one image recording of at least one section of the passenger compartment and
an evaluation unit connected down-line of the camera that detects and counts the passengers of the vehicle in the image recording.

2. The onboard unit according to claim 1, wherein the transceiver transmits the number of passengers to the central processing unit.

3. The onboard unit according to claim 2, wherein the transceiver also transmits the image recording to the central processing unit.

4. The onboard unit according to claim 3, wherein the evaluation unit obscures the detected passengers of the vehicle in the image recording before transmission thereof.

5. The onboard unit according to claim 1, wherein the onboard unit contains a memory for archiving the image recording and/or the number of passengers.

6. The onboard unit according to claim 1, wherein it can be fastened in the region of the windscreen of the vehicle and the camera is arranged on its rear side remote from the windscreen.

7. The onboard unit according to claim 1, wherein at least one further camera is directed towards the vehicle environment in front of the vehicle.

8. The onboard unit according to claim 7, wherein an evaluation unit, which detects license plate numbers of other vehicles in the image recording, is connected down-line of the further camera.

9. The onboard unit according to claim 8, wherein the evaluation unit obscures the detected license plate number in the image recording.

10. The onboard unit according to claim 1, wherein the camera creates one or more image recordings in each case at periodic, predefined or random instants in time.

11. The onboard unit according to claim 1, wherein the camera creates at least one image recording in response to a request received via the transceiver.

12. The onboard unit according to claim 1, wherein the onboard unit has an object detector, which upon detection of a given object in the vicinity of the vehicle causes the camera to record an image.

13. The onboard unit according to claim 12, wherein the object detector is an RFID or DSRC detector for wireless recognition of an RFID or DSRC object.

14. The onboard unit according to claim 12, wherein the object detector is an optical detector for detecting the presence of a visible object in the environment of the vehicle.

15. The onboard unit according to claim 14, wherein the optical detector detects the presence of an object that may be remaining stationary in a moving environment of the vehicle.

16. The onboard unit according to claim 1, wherein the onboard unit contains an acceleration sensor, which in the event of an acceleration exceeding a threshold causes the camera to record an image.

17. The onboard unit according to claim 1, wherein the onboard unit contains a satellite navigation receiver to provide the image recording with the location and time data of its creation.

18. The onboard unit according to claim 1, wherein the transceiver is a DSRC, WAVE or mobile communications transceiver.

19. The onboard unit according to claim 1, wherein the further camera is configured for infrared light.

20. The onboard unit according to claim 1, wherein the camera is formed by a time of flight camera.

21. A method for the passenger number-dependent application of a toll to a vehicle by means of an onboard unit according to claim 1, comprising:
creating an image recording of a passenger compartment of the vehicle by means of the camera of the onboard unit;
detecting and counting the passengers of the vehicle by means of the evaluation unit of the onboard unit; and
in the onboard unit, calculating a toll as a function of the number of passengers.

22. A method for the passenger number-dependent application of a toll to a vehicle by means of an onboard unit according to claim 2, comprising:
creating an image recording of a passenger compartment of the vehicle by means of the camera of the onboard unit;
detecting and counting the passengers of the vehicle by means of the evaluation unit of the onboard unit;
transmitting the number of passengers to a central processing unit by means of the transceiver of the onboard unit; and
in the central processing unit, calculating a toll as a function of the received number of passengers.
